(19) United States
(12) Patent Application Publication
(10) Pub. No.: US 2008/0176195 A1
(43) Pub. Date: Jul. 24, 2008

(54) SYSTEM AND TOOLS FOR LEARNING

(76) Inventor: Fabio ALVARADO, Kennesaw, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/624,398

(22) Filed: Jan. 18, 2007

(51) Int. Cl. G09B 19/02

(52) U.S. Cl. 434/188

(57) ABSTRACT

A method of memorizing information including imprinting a plurality of mental exercise cards with the information to be memorized and reviewing the mental exercise cards until the information is substantially memorized. The method also includes completing at least one written exercise card and at least one review card. The written exercise card includes a memorization test covering a portion of the information, while the review card includes a memorization test covering substantially all of the information.

### TECHNICAL FIELD

The present invention relates generally to the field of education, and more particularly, to a system and tools for learning educational material quickly and efficiently.

### BACKGROUND OF THE INVENTION

Many students of all ages and abilities have difficulties at some point in their academic careers understanding and retaining educational material. This difficulty often stems from the students inability to properly and efficiently study the material or subject. In many instances, a student may diligently study and review a difficult subject, while still not being able to remember and learn the material. In other instances, a particular subject matter may take a student an abnormally long time to understand and comprehend. In these instances, even a student that is willing and determined to learn a particular subject may get discouraged or quit because of the difficulty in actually retaining the material.

Other students may not be as highly motivated and do not enjoy learning. These students often do not put much effort into learning any particular subject, and when faced with a difficult subject, will not even attempt to learn. These students in particular may quickly fall behind in school or in other academic curriculums. Many of these students often complain that the subject matter is boring and/or difficult, when in fact, these students merely do not understand how to properly study in order to retain and comprehend the material.

Furthermore, it has been found that many schools simply do not teach students efficient means of studying and learning material. Often, school teachers are burdened by large numbers of students and they are not able to effectively work with each student. Therefore, students are often left on their own to study and learn educational material. This often contributes to the development of poor study habits and ineffective means of learning a particular subject matter. For example, grade school students are typically required to learn addition, subtraction, multiplication, and division tables, but are not taught how to learn them. Teachers often merely test students on their knowledge of these tables, but generally they do not work with each student individually. Under these circumstances, the students are left to learn the tables on their own, or request help from a parent or relative. Unfortunately, many parents seem to be too busy to teach their children these tables, or are unable to do so.

Therefore, it can be seen that needs exist for a system and/or tools that can quickly and efficiently teach a student difficult subject matter, while making the material fun for the student to learn. It is to the provision of these needs and others that the present invention is primarily directed.

### SUMMARY OF THE INVENTION

In one aspect, the present invention provides a method for memorizing information including imprinting a plurality of mental exercise cards with the information to be memorized and reviewing the mental exercise cards until the information is substantially memorized. The method also includes completing at least one written exercise card and at least one review card. The written exercise card includes a memorization test covering a portion of the information, while the review card includes a memorization test covering substantially all of the information.

In another aspect, the present invention is a system for use by at least one student to memorize information including a plurality of mental exercise cards, a plurality of written exercise cards, and at least one review card. Optionally, the mental exercise cards are imprinted with the information to be memorized by the student. Optionally, the written exercise cards tests the student's memorization of a portion of the information to be memorized. Optionally, the at least one review card tests the student's memorization of the information to be memorized in its entirety.

In still another aspect, the invention is a method of creating a system to teach a student learning skills including creating a first set of mental exercise cards, creating a second set of reusable written exercise cards, and creating at least one review card. The method also includes imprinting the first set of cards with information to be learned. The second set of cards also includes at least one memorization test covering a portion of the information to be learned and the at least one review card includes at least one memorization test covering substantially all of the information to be learned.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows the multiplication tables for the numbers 0-12 arranged on a card according to an example embodiment of the present invention.

FIG. 2 shows the front side of a deck of mental exercise cards used with an example embodiment of the system of the present invention.

FIG. 3 shows the back side of the deck of mental exercise cards of FIG. 2.

FIG. 4 shows the front side of a set of written exercise cards used with an example embodiment of the system of the present invention.

FIG. 5 shows the back side of the set of written exercise cards of FIG. 4.

FIG. 6 shows the front side of a review card used with an example embodiment of the system of the present invention.

FIG. 7 shows the back side of the review card of FIG. 6.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

With reference to the drawing figures, a new and improved system for learning and retaining information embodying the principles and concepts of the present invention will be described.

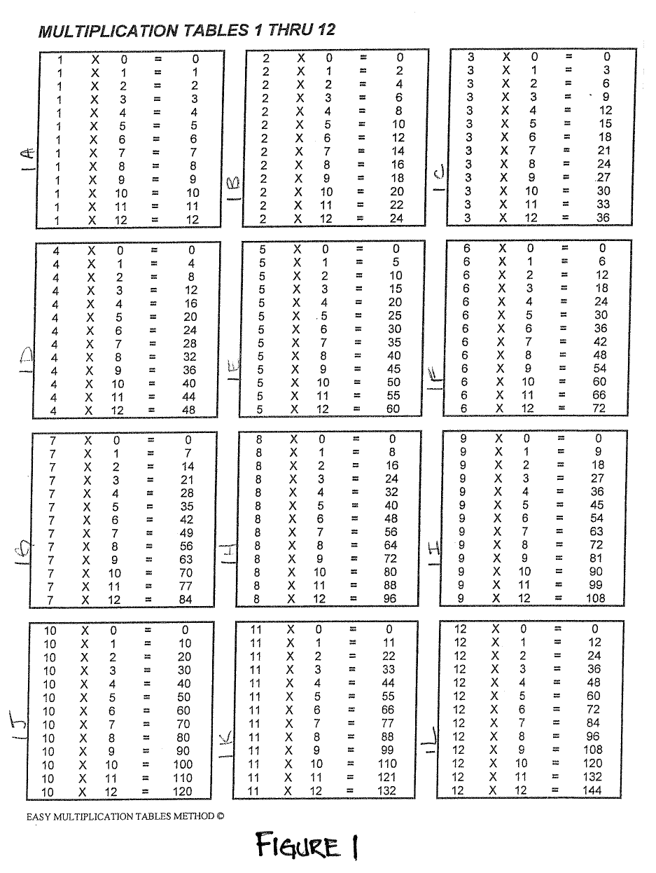

Turning now to FIGS. 1-7, there is shown an exemplary embodiment of the system for learning and retaining mathematical tables according to the present invention. Although the drawing figures depict a system for learning math multiplication tables, other embodiments of the system are used to learn addition, subtraction, division, and other mathematical tables. Additionally, still other embodiments of the system are used to study and learn other subject matters, often wherein memorization is the primary objective, such as chemistry periodic tables, amortization schedules, mathematical fractions, spelling, biology, etc. In fact, as every area of study typically requires at least some memorization, it is anticipated that this system can be adapted for use with almost any subject matter.

Typically, grade school students are required to know the multiplication tables 1a-1l, as seen in FIG. 1, which encompasses all of the possible multiplications of the numbers between 0-12. Multiplication is the process of finding the product obtained by repeated additions of a multiplicand a specific number of times (multiplier). For example, the product of the number two multiplied four times equals eight, or 2×4=8. In this equation, the number 2 is the multiplicand, the number 4 is the multiplier, and the number 8 is the product. This equation can also be written as 2+2+2+2=8. Generally, students must first learn the process of multiplication before moving on to division, fractions, and other more difficult mathematical concepts. Therefore, it is imperative that students successfully memorize the multiplication tables in an efficient way.

It has been found that the system of the present invention is most effective when having two or more students participate; however, the system is also effective when used by only one student to self-study. In example embodiments, the system of the present invention includes twelve lessons designed to effectively and efficiently teach a student the mathematical multiplication tables. Although, in alternative embodiments, more or fewer lessons can be used depending on the skill level of the student and the subject matter being studied. It is recommended, but not necessary, that a student utilizing the present system learn the multiplication tables learn one lesson a day, wherein each lesson takes about 45 minutes-1 hour to complete. Therefore, it is recommended that the entire system take about 12 hours to complete. Of course, the completion time of the course is entirely dependent on the efforts and abilities of the student. For other subject matters, such as addition or subtraction, the completion time of the course may vary significantly.

In example embodiments, the first lesson explains to the student(s) that the product of the number zero multiplied by any number is equal to zero. The student is then taught that the product of the number one multiplied by a multiplier is equal to the multiplier. The student(s) can also be reminded that the order of the factors (multiplicand and multiplier) in any equation does not change the product of the factors. Charts or tables can be shown to the student to reinforce this lesson. In alternate embodiments the first lesson can be used to introduce a student to the system, or to cover introductory material.

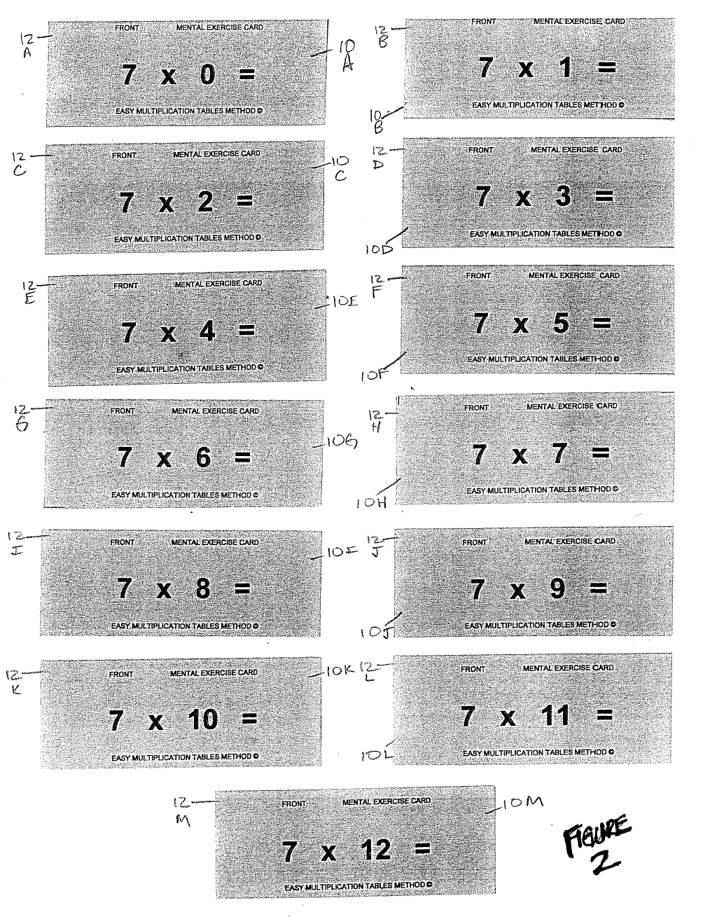

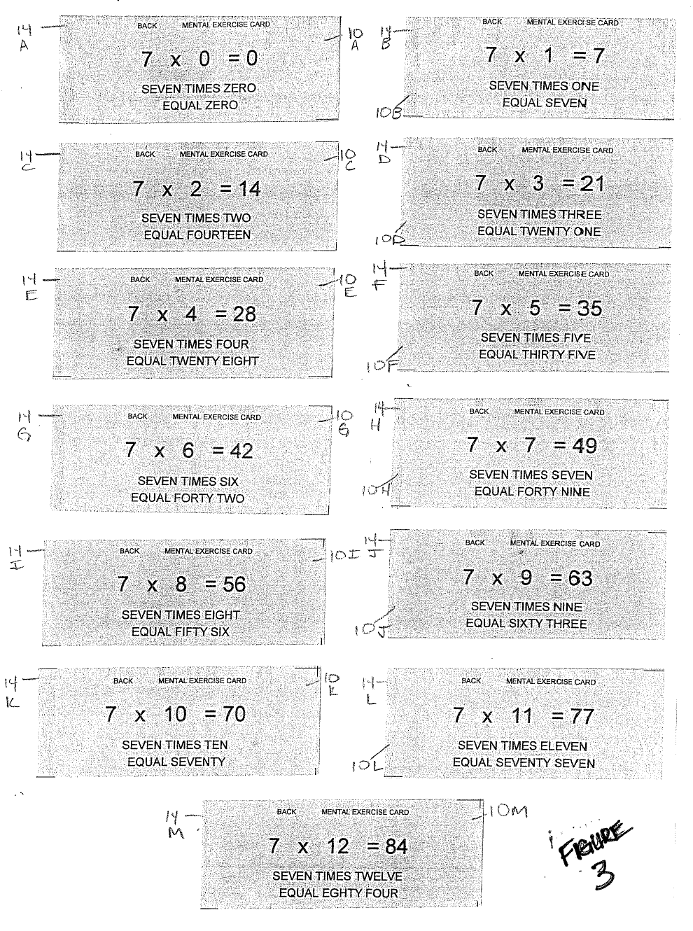

In the depicted embodiments, each additional lesson teaches the student(s) the products of a particular multiplicand and multipliers between 0-12. For example, lesson two teaches the student(s) the products of the multiplicand two (e.g. 2×0, 2×1, 2×2, . . . , 2×12) and lesson three the products of the multiplicand three (e.g. 3×0, 3×1, 3×2, . . . , 3×12). These additional lessons preferably include two components. The first component of each lesson comprises a set of mental exercise cards 10a-10m as seen in FIGS. 2-3. In preferred example embodiments, thirteen mental exercise cards 10 are used for each multiplication table lesson. The mental exercise cards 10 each have a front side 12 and a back side 14. The front sides 12 of the cards 10 can show the multiplicand and the multiplier, but not show the product. The back sides 14 of the cards 10 show the product of the multiplicand and the multiplier. Optionally, the back sides 14 also show the entire equation and the words that embody the equation as seen in FIG. 3. The cards 10 can be created from paper, laminated paper, plastic, or a combination thereof.

In example embodiments, the mental exercise cards 10 are to be arranged in sequence from the multiplicand×zero to the multiplicand×twelve. For example, the cards reading 7×0, 7×1, 7×2, 7×3, 7×4, . . . , 7×12, should be arranged in sequence as seen in FIG. 2. The student(s) then places the first four cards together as if the student(s) was holding a deck of cards, such that only one card can be seen at a time. In alternate embodiments, more or fewer than four cards can be used initially depending on the subject matter being studied, and the skill of the student(s). When two students are studying together, the front of the card 12 is to be facing the first student being questioned, while the back of the card 14 is to be facing the second student who is questioning the first. The second student shows the first student the first card in the sequence, and asks the first student to read the card aloud and then state the answer. In this example, the first student would say “seven times zero equals zero.” If the first student correctly states the answer, the next card in the sequence is brought to the front of deck and the process is repeated, e.g. the first student would say “seven times one equals seven.” The cards 10 are continually rotated in this manner until the first student is able to answer each card quickly and correctly. If the student fails to answer a card correctly, the second student places that card back into the deck, such that part of the card is sticking out of the deck. The positioning of the card(s) in such a manner alerts the second student that the first student is having trouble with that particular card and the second student can then rotate that particular card to the front of the deck more frequently until the first student is able to quickly and correctly state the answer. Once the first student is able to give a fast and correct answer to all of the cards in the deck, the second student can add additional mental exercise cards 10 from that lesson to the deck. The second student can continue to add cards to the deck as long as the first student has substantially memorized the previous ones. However, it is recommended that no new cards be added if the first student has not successfully memorized three of the cards at any time, such that no more than three cards are sticking out of the deck at any given time.

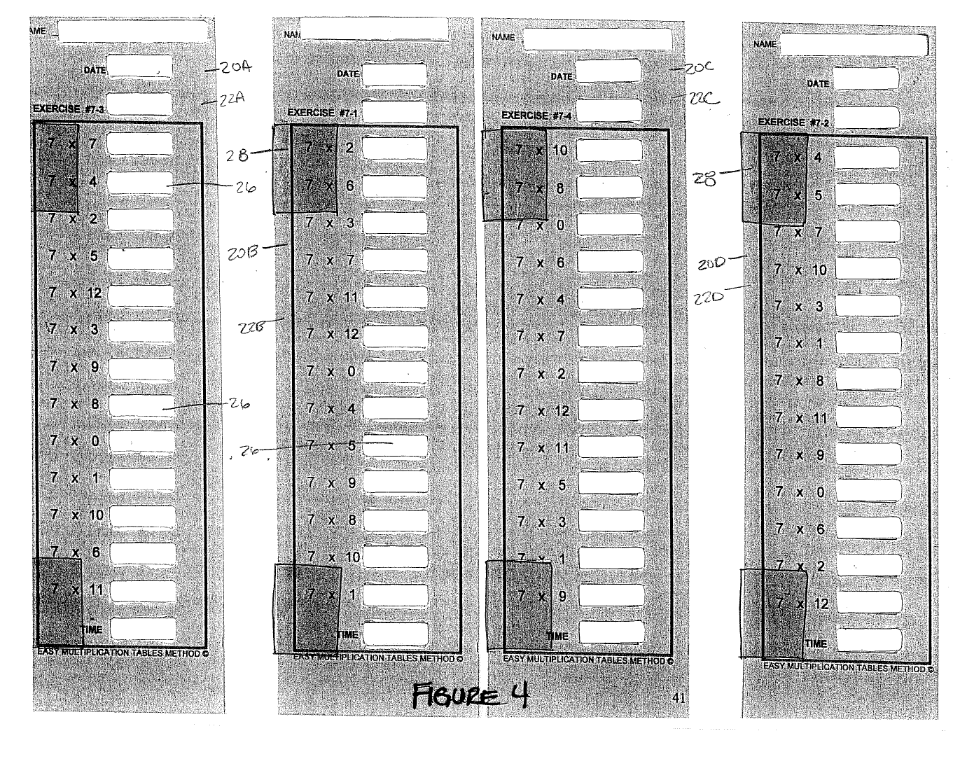

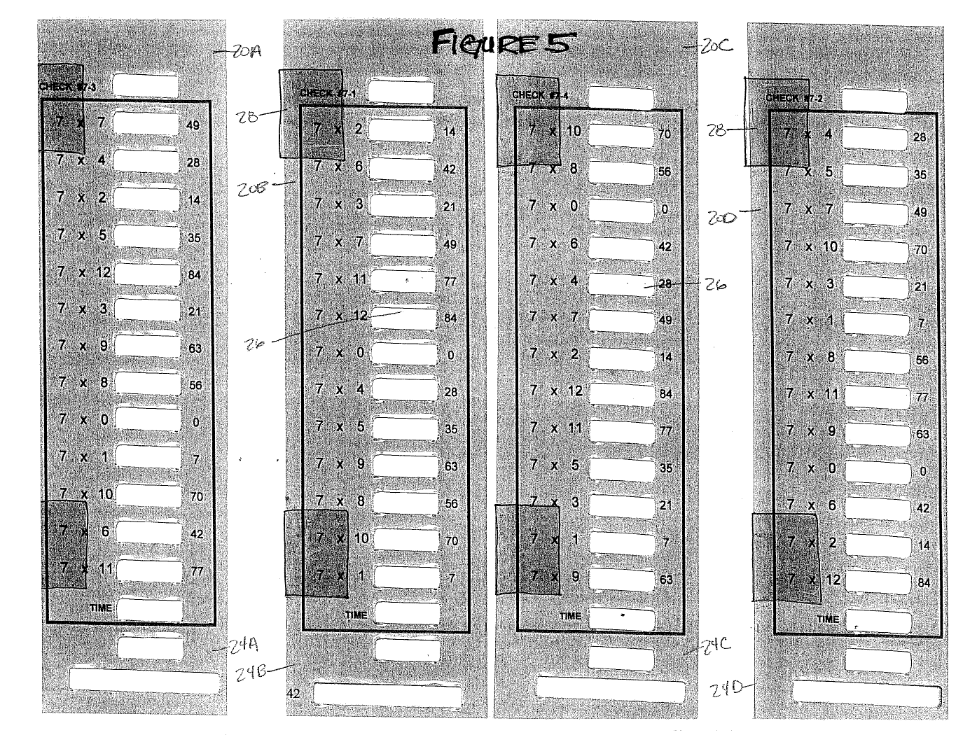

Once the first student has memorized all of the cards 10 for a particular lesson, the student(s) can engage in the second component of each lesson. In example embodiments, the second component includes reusable written exercise cards 20a-20d as seen in FIGS. 4-5. In preferred example embodiments, four written exercise cards 20 are used for each lesson. In alternate embodiments, more or fewer written exercise cards 20 are used depending on the subject matter and/or the skill level of the student. In still other alternate embodiments, the system does not include written exercise cards 20 at all. The written exercise cards can comprise a front side 22 and a back side 24. The front side 22 of the card lists several combinations of the multiplicand for that lesson and various multipliers as seen in FIG. 4. The cards 20 can also have one or more slots 26 cut out for the student(s) to write the answer to these equations. In preferred example embodiments, the front side 22 of each card has all thirteen combinations of multipliers of the multiplicand for that lesson. Optionally, the front side 22 of the card can also include slots for inserting a student's name, the date, and/or the exercise number. The back side 24 of the card can re-list the equations as they appear on the front side 22 of the card, in conjunction with the answers to the equations from the front of the card 22, as seen in FIG. 5. The cards 20 can be created from paper, laminated paper, plastic, or a combination thereof.

The cards 20 can be placed over a piece of paper or other writing surface when a student(s) is ready to begin, such that the student is viewing the front 22 of the card. The card can be attached to a piece of paper with a paper clip, tape, built-in clips 28, or any other conventional fastener for securing the same. In example embodiments, the built-in clips 28 are transparent plastic that frictionally hold the cards 20 to the writing surface. The student(s) can then attempt to write the answer to each equation in the slots 26 provided. Optionally, the student attempting the written exercises can be timed with a stopwatch, or other timing device. Once the student has attempted to answer all of the equations listed on the front side 22 of the card, the student can flip the card over and line it up with the student's responses. The student can then compare his/her responses with the correct answers and can write down his/her score for record keeping purposes. The student(s) can repeat these written exercises with any of the cards 20 for each lesson. In example embodiments of the system, it has been found that a student has sufficiently memorized the multiplication table for a particular lesson when the student can answer all thirteen equations for a particular multiplicand in fewer than 30 seconds. If the student(s) is having trouble correctly answering the written exercise cards 20, the student(s) can repeat the mental exercises. Once a student has successfully completed a lesson, the student is ready to move on to the next lesson until all lessons have been completed.

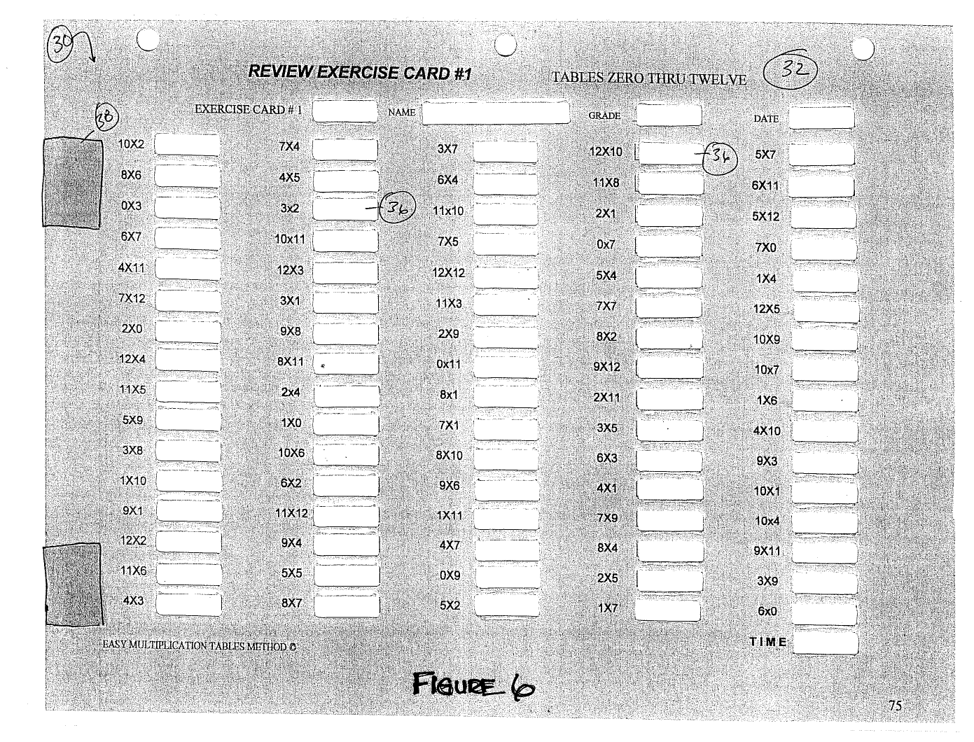

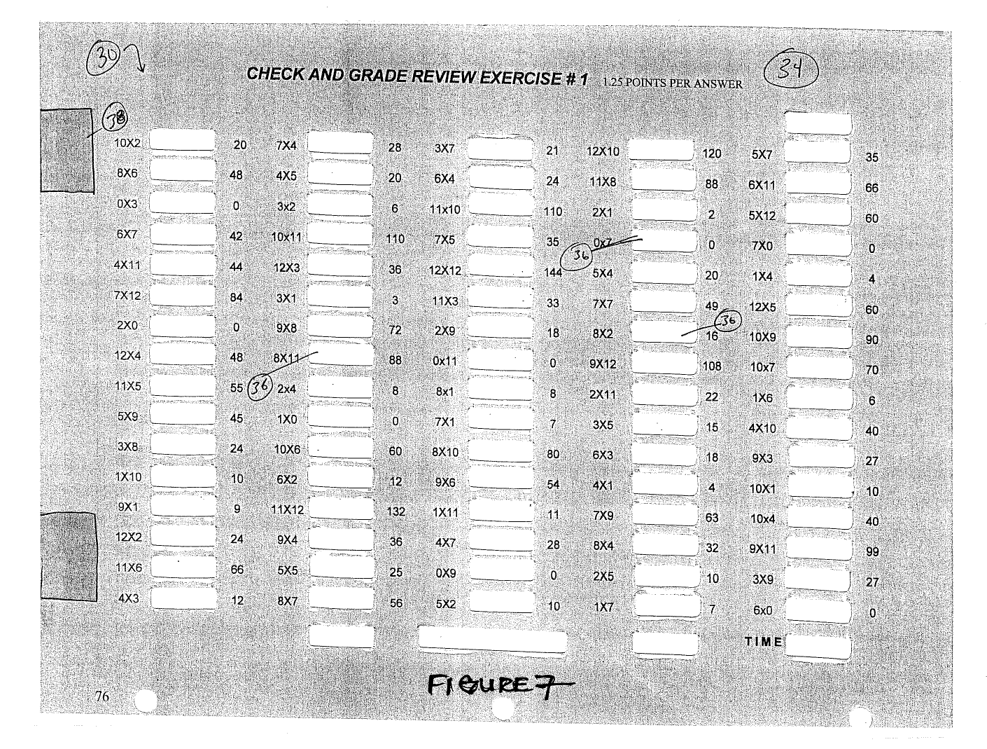

Optionally, after a student has completed all of the lessons of the system, the student can then participate in one or more review exercises. Each review exercise can comprise a review exercise card 30 as seen in FIGS. 6-7. Similar to the written exercise cards 20, the front side 32 of the review card 30 includes several equations that the student must answer and typically includes slots 36 for the student to write in his/her responses. In preferred example embodiments, the review cards 30 have 80 questions per card, although more or fewer questions can be used. Preferably, the review cards 30 combine multiplications (or additions, subtractions, etc.) learned from previous lessons into one exercise, such that the student(s) can test their knowledge of all of the multiplication tables. The back side 34 of the review cards 30 includes the same equations with their correct answers. The review cards 30 can be placed on top of a piece of paper or other writing surface, and can utilize paper clips, tape, or built-in clips 38 to secure the cards to the same. As with the written exercises, a student participating in the review exercises can be timed with a stopwatch or other timing device. Generally, it has been found that students who are able to complete a review exercise card having 80 questions in under five minutes with 3 or fewer mistakes has successfully learned the multiplication tables.

In addition to the tools described above, the system can also include pencils, paper, paper clips, erasers, and/or a stop watch or other timing device. Furthermore, the system of the present invention can be compiled into a kit, such as a book, binder, or placed in a folder for convenience.

While the drawing figures depict embodiments of the present invention pertaining to multiplication tables, other embodiments of the system are utilized to teach students addition, subtraction, division, fractions, spelling, or any other subject matter where memorization is required.

While the invention has been described with reference to preferred and example embodiments, it will be understood by those skilled in the art that a variety of modifications, additions and deletions are within the scope of the invention, as defined by the following claims.

What is claimed is:

1. A system for use by at least one student to memorize information comprising:
a plurality of mental exercise cards;
a plurality of written exercise cards; and
at least one review card.

2. The system of claim 1, wherein the mental exercise cards are imprinted with the information to be memorized by the student.

3. The system of claim 2, wherein the written exercise cards test the student's memorization of a portion of the information to be memorized.

4. The system of claim 3, wherein the at least one review card substantially tests the student's memorization of the information to be memorized in its entirety.

5. The system of claim 4, wherein the information to be memorized is multiplication equations.

6. The system of claim 4, wherein the information to be memorized is addition equations.

7. The system of claim 4, wherein the information to be memorized is subtraction equations.

8. The system of claim 4, wherein the information to be memorized is division equations.

9. The system of claim 1, wherein the plurality of mental exercise cards, the plurality of written exercise cards, and the at least one review card are bundled together in a kit.

10. A method of learning the products of a plurality of multiplication equations comprising:
reviewing a plurality of mental exercise cards representing the products to be learned;
completing a plurality of written exercise cards; and
completing at least one review card.

11. The method of claim 10, wherein the plurality of mental exercise cards comprises thirteen cards.

12. The method of claim 11, wherein the mental exercise cards further comprise a front side and a back side, wherein the front side includes a multiplicand and a multiplier, and wherein the back side includes the multiplicand, the multiplier, and the product of the multiplier and the multiplicand.

13. The method of claim 10, wherein the plurality of written exercise cards comprises four cards.

14. The method of claim 13, wherein the written exercise cards further comprise a front side and a back side, wherein the front side includes a plurality of multiplication questions, wherein the multiplication questions include a constant multiplicand and a variable multiplier, and wherein the backside includes the answers to the multiplication questions.

15. The method of claim 14, wherein the written exercise cards further comprise thirteen multiplication questions.

16. The method of claim 10, wherein the at least one review card comprises a front side and a back side, wherein the front side includes a plurality of multiplication questions, wherein the multiplication questions include a variable multiplicand and a variable multiplier, and wherein the backside includes the answers to the multiplication questions.

17. The method of claim 16, wherein the at least one review card further comprises two review cards.

18. A method of creating a system to teach a student learning skills comprising:
creating a first set of mental exercise cards;
creating a second set of reusable written exercise cards;
creating at least one review card; and
imprinting the first set of cards with information to be learned;
wherein the second set of cards comprise at least one memorization test covering a portion of the information to be learned; and
wherein the at least one review card comprises at least one memorization test covering substantially all of the information to be learned.

19. The method of claim 18, further comprising bundling the first set of mental exercise cards, the second set of reusable written exercise cards, and the at least one review card into a kit.
